(19) United States
(12) Patent Application Publication
(10) Pub. No.: US 2019/0138086 A1
(43) Pub. Date: May 9, 2019

(54) HUMAN MACHINE INTERFACE

(71) Applicants: Shanghai XPT Technology Limited, Shanghai City (CN); Mindtronic AI Co.,Ltd., Grand Cayman (KY)

(72) Inventors: Mu-Jen Huang, Taipei City (TW); Ya-Li Tai, Taoyuan City (TW); Yu-Sian Jiang, Kaohsiung City (TW)

(21) Appl. No.: 16/234,579

(22) Filed: Dec. 28, 2018

Related U.S. Application Data
(63) Continuation-in-part of application No. 15/935,053, filed on Mar. 25, 2018.

(30) Foreign Application Priority Data
Nov. 9, 2017 (CN) 201711099567.9
Nov. 9, 2017 (CN) 201721487383.5
Dec. 29, 2017 (CN) 201711482541.2
Dec. 29, 2017 (CN) 201721900090.5
Mar. 21, 2018 (CN) 201810237040.6
Mar. 21, 2018 (CN) 201820387687.2

(51) Int. Cl. G06F 3/01; G06F 3/0482; G06F 3/0485

(52) U.S. Cl. CPC G06F 3/012; G06F 3/0482; G06F 2203/04806; G06F 3/013; G06F 3/0485

(57) ABSTRACT

A human machine interface is disclosed. The human machine interface is operable on an electronic device. The method of operation includes: sensing a user motion of a user, translating the user motion into an associated instruction and consequently instruct the electronic device to execute a binding function.

### CROSS REFERENCE TO RELATED APPLICATIONS

This patent application is a continuation-in-part application and claims the benefit of U.S. patent application Ser. No. 15/935,053 (“'053 application”) filed on 25 Mar. 2018 which is incorporated by reference herein.

### BACKGROUND OF THE INVENTION

### 1. Field of the Invention

The present invention relates to a human machine interface of an electronic device and a method of commanding an electronic device through a human machine interface.

### 2. Description of the Prior Art

People familiar with UI design understand that underneath a user interface are layers in hierarchy. The layers define pages where various functional buttons are disposed thereon to control operations of an electronic device. That is, through a selection of a functional button, a user can control the corresponding operation of the electronic device. However, sometimes when a user interface is poorly designed, the user may have to go through pages and pages to find the operation he/she intends. For instance, assuming a user wants to change the background theme of a touchscreen-based media displayer. In this case, the user may firstly press the functional button on the main page where the system configuration located, then find the change of theme button in the subordinated layer, and subsequently select the background theme he/she wishes in the next inferior layer, and lastly confirm the selection and the setting. The above manual operations may be feasible as far as handheld devices, such as a mobile phone, and personal computers are concerned. However, when it comes to a driver who is driving a vehicle, any slightly more complicated operation will pose a great threat and is extremely dangerous. Thus, there is a need to provide a method for drivers to control facilities installed in vehicle in safer manners.

### SUMMARY OF THE INVENTION

According to an embodiment of the present disclosure, a method of commanding an electronic device is provided. The method includes the following actions: providing a user interface where a plurality of functional objects are presented on a screen. Each of the functional objects has an underlying function. The method also includes: detecting at least one user motion; translating the user motion to at least one instruction, wherein the instruction includes a selection of one functional object; and instructing the electronic device to perform the underlying function of the selected functional object.

According to another embodiment of the present disclosure, an electronic device having a hand-free user interface is provided. The electronic device includes: a screen displaying a page containing a plurality of functional objects, wherein each of the functional objects has an underlying function; a sensor configured to receive at least one user motion made by a user; and a processor configured to translate the user motion into at least one instruction, wherein the instruction includes a selection of one functional object; wherein, upon a confirmation of the selection, the processor causes the electronic device to perform the underlying function of the selected functional object.

According to another embodiment of the present disclosure, an electronic device having a user interface upon which a user command the electronic device through a plurality of user motions associated with instructions to the electronic device is further disclosed. The electronic device includes: a screen configured to display a page containing a plurality of functional objects to the user, wherein each of the functional objects corresponds to an underlying function; a sensor configured to detect at least an eye-related motion; and a processor configured to translate the eye-related motion into an instruction operable to move an indicator on the screen for a selection of one of the functional objects; wherein the eye-related motion is determined based on the user's gaze vector and gaze point on the screen; wherein, upon a confirmation of the selection, the processor causes the electronic device to perform the underlying function of the selected functional object.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an electronic device according to an embodiment of the present disclosure.

FIG. 2A is a schematic diagram of operating the screen through the human-machine interface according to an embodiment of the present disclosure.

FIG. 2B is a schematic diagram of operating the screen through the human-machine interface according to an embodiment of the present disclosure.

FIG. 2C is a schematic diagram of a displayed page with an indicator according to an embodiment of the present disclosure.

FIG. 3 is a flowchart of a method 30 for interacting with a user via a user interface according to an embodiment of the present disclosure.

FIGS. 4A-4C illustrate detailed implementations of controlling a screen to display a page according to the head-related motions.

FIG. 5 is a schematic diagram of the control of the position of the indicator on the screen according to the eye-related motions.

### DETAILED DESCRIPTION

The present disclosure provides a human-machine interface (HMI) operable to an electronic device installed in a vehicle. The disclosed HMI is operated through binding user motions including head-related, facial-related and/or eye-related motions. By exercising one user motion exampled above, the electronic device perform a binding function accordingly.

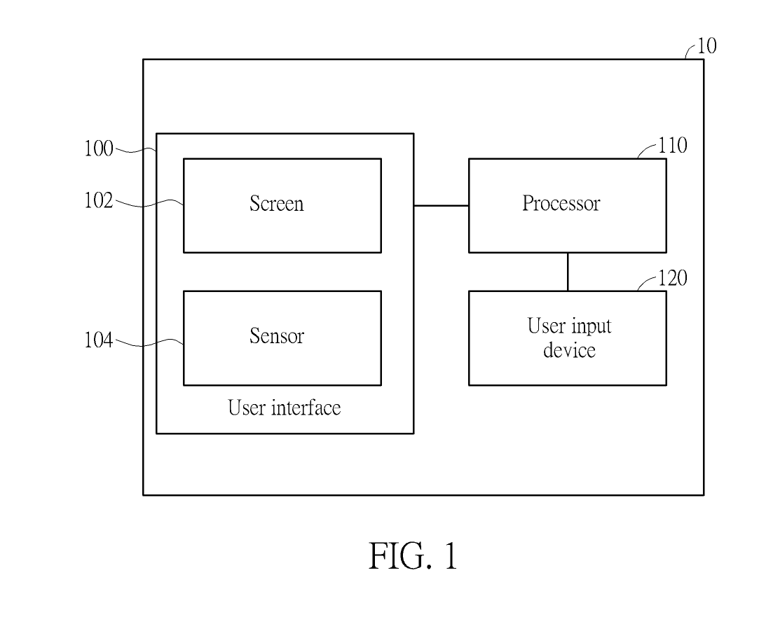

FIG. 1 illustrates a schematic diagram of an electronic device 10 operable through a human-machine interface of an embodiment of the present disclosure. In one embodiment, the electronic device 10 is disposed in a vehicle. The electronic device 10 may be an infotainment, a navigator, or a digital dashboard, etc. that provides abundant information to users in the vehicle.

The electronic device 10 includes a user interface 100 and a processor 110. The user interface 100 provides a medium in between a user and the electronic device 10. The user interface 100 includes a screen 102 and a sensor 104. In an embodiment, the screen 102 may be any type of display device such as a liquid crystal display (LCD) or an organic light emitting diode display (OLED display); and additionally, the screen 102 may be a touch screen of any sort.

In an embodiment, the sensor 104 may be any type of sensor capable of obtaining and appreciating user data. The sensor 104 may be a visible light camera, infrared camera, light sensor, or combinations of multiple types of sensors. In an alternative embodiment, the sensor 104 may be independent to the user interface 100.

In the instant disclosure, the user data includes various of user motions that are perceived by the sensor 104. In an embodiment, the sensor 104 detects head-related motions constituted by, for instance, a change of head pose, a change of head position, and/or any combinations of the above. The head position may be defined by a relative position of the user's head in view of the sensor 104, or by a relative position of the user's head in relation to the screen 102. The head-related motions may also include head poses such as a head nod, a head shake, and a head tilt. Further, others such as a yaw rotation, a pitch rotation and a roll rotation are also considered as head-related motions in the embodiment.

In an embodiment, the sensor 104 detects eye-related motions including, for example, a change of gaze vector, a change gaze point and/or any combinations of the above. The gaze vector refers to a gaze from the user's eyes toward the direction where the user is looking at. The gaze vector may be derived from at least one of the head position, the head pose, the light reflected from the iris, the iris position and/or the pupil position. The gaze vector may be represented with reference to a world coordinate system, a facial coordinate system, or a display coordinate system. The gaze point is the point of interest on a display screen where the user stares at. The gaze point may be derived by reference to the gaze vector and the positions of two eyes.

In an embodiment, the sensor 104 detects facial-based motions including, for instance, a change of facial expression, a series of facial motions, and/or any combinations of the above. A facial-based motion may be a static facial expression, or a dynamic facial motion. The facial-related motion in accordance with the present disclosure may include a smile, a laugh, an opened mouth, an eye blink or a wrinkled nose and so on.

In an embodiment, the processor 110 may be a central processing unit (CPU), a microprocessor, a micro controller unit (MCU) or an application-specific integrated circuit (ASIC). The processor may be implemented with hardware and/or software.

In the present disclosure, numbers of user motions are predefined and associated with instructions and functions. Upon receiving a user motion from the sensor 104 via the user interface 100, the processor 110 translates the user motion into a corresponding instruction given to the electronic device 10 to perform an underlying function accordingly. For instance, if a functional object namely “System Configuration” is selected and confirmed, through several operations of user motions, the electronic device will carry the function for the user to change settings of the electronic device 10.

In one embodiment, the head-related motions are relevant to the control the way in which the functional objects are laid out in a page and displayed on the screen 102. Exemplarily, a head-related motion may instruct the screen 102 to pan the image displayed thereon; and another head-related motion may cause the screen 102 to zoom in the page. Based on the similarly concept, various user motions can be defined and associated with different instructions.

Sometimes a page may be too larger to fit into a display screen. One way to show the entire page is by reducing its resolution to accommodate the screen size. But the content on the page may be suffered and become difficult to read. Alternatively, one may choose to only display the page partially, and meanwhile allow the viewer to pan, zoom-in and zoom-out the page manually. As iterated, those manual operations are impractical when it comes to drivers.

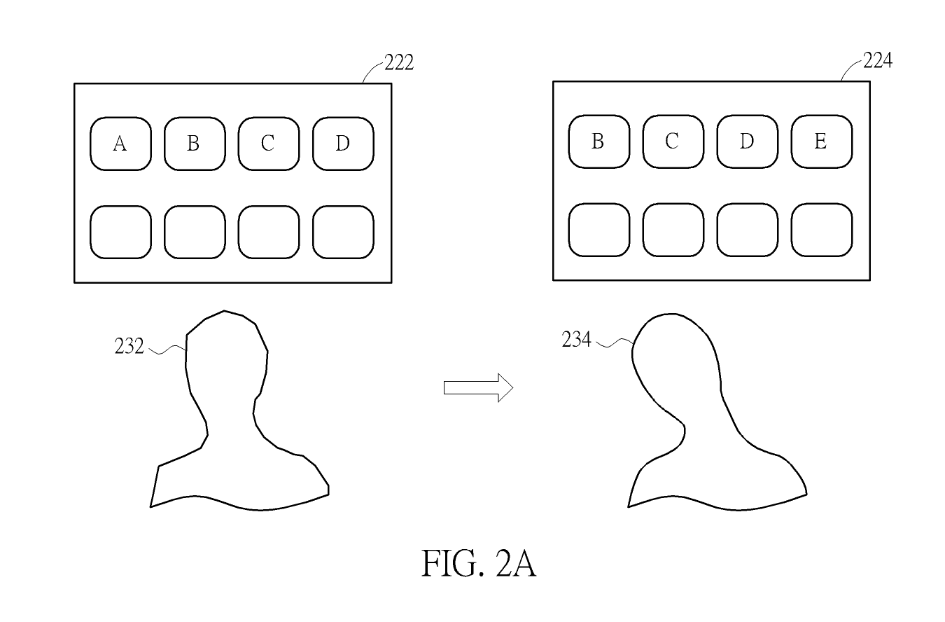

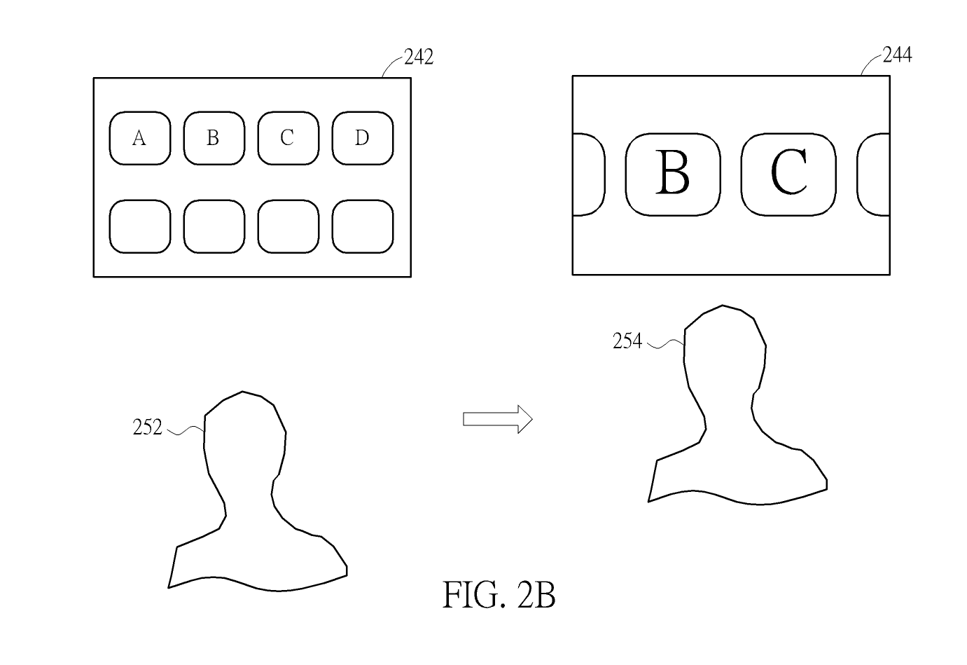

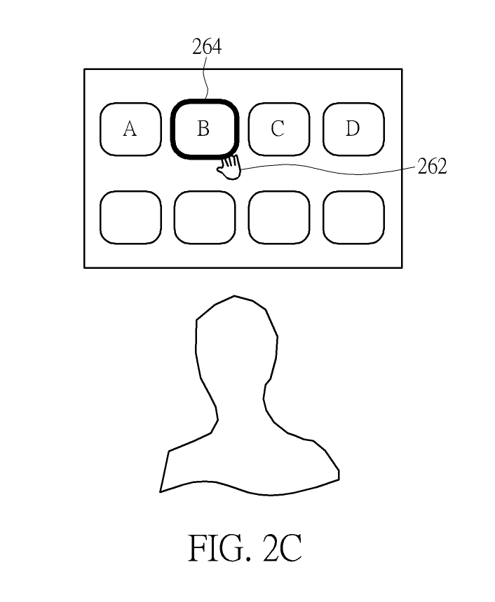

FIG. 2A illustrates an embodiment of operating the screen 102 through the human-machine interface in accordance with the present disclosure. Assuming numbers of head-related motions are predefined and associated with various of display functions operable by the screen 102. For instance, if a user turns his/her head aside, an instruction of panning the page displayed on the screen toward the direction consistent with the head is given to the screen 102. Specifically, if the user turns his/her head to the right, the page displayed on the screen 102 is panned right, and vice versa. As shown in FIG. 2A, assuming the page contains five functional objects respectively labeling “A”, “B”, “C”, “D”, and “E”. Given the limited screen size of the screen 102 and the preset resolution, the screen 102 can only show the partial functional objects: “A”, “B”, “C”, and “D”. Conceptually, according to the instant disclosure, the user may simply turn his/her head to the left side to pan the page right; consequently, the user is able to see the functional object “E” which was not presented previously. Specifically, the screen 102 presents a first set of functional objects (i.e. “A”, “B”, “C”, and “D”) to the user and leaves a second set of functional objects (i.e. “E”) unseen to the user. The user issues a pan-left instruction to the screen 102 by turning his/her left. The sensor 104 appreciates a positional change of the user's head probably by several image processing steps. The result is sent to processor 110 for interpretation. The processor 110 translates the head-related motion into the associated instruction to control the screen 10 and consequently the second set of functional objects which was unseen is presented on the screen 102. From the user's perspective, the page is effectively paned left. As shown in FIG. 2A, when the user's head position changes from 222 to 224, the displayed page is panned left (e.g., changed from 232 to 234). The functional objects shown on the active displaying area therefore changes from “A”, “B”, “C”, and “D” to “B”, “C”, “D”, and “E”. On the other hand, if the user turns the head to right, the page is panned right accordingly. If the user lifts his/her head, the page is scrolled up, and vice versa. In the instance embodiment, the user's head is acting as a mouse wheel or a touch pad allowing users to move a displayed page in any directions. Depending on the degree of the movement, the portion of the page therefore shown on the screen 102 changes accordingly. The above examples are provided merely to illustrate how the present disclosure works without intention to limit the scope of disclosure.

In another implementation, there are user motions designed and designated to zoom in and out the page on the screen 102. Conceptually speaking, the user may simply lean to the screen to zoom in the page; on the other hand, is the user is moving his/her head away from the screen, the page on the screen 102 is zoomed out. As shown in FIG. 2B, the user may move his/her head toward the screen (e.g., changes from 242 to 244) to zoom in the page) to get a larger view of items “B”, and “C”.

Although the above examples are separately discussed, it should be understood that one user motion may be operated in conjunction another or others. Continuing to the above two examples, the user may firstly instruct the screen 102 to zoom in the page by leaning the head toward the screen, and subsequently instruct the screen 102 to display the unseen portion on the right-hand side by turning the head to the left. By the operations, the user can see, for instance, an enlarged size of the blocks C and D on the screen.

In another embodiment, the user interface 100 may accept commands made by eye-related motions. Assuming an indicator is designed underneath the user interface 100 to indicate which functional object on the screen 102 is being pointed to. The indicator functions like a cursor but may be in any other forms. For instance, instead of having a pointer, the indictor may be in the form of color-highlighting, frame-highlighting, various curving effects, etc. to show what functional object on the screen 102 is being pointed to. FIG. 2C shows an example of the embodiment. As shown, the user interface 100 has a hand-shaped cursor to indicate the functional object “B” on the screen 102 is being pointed to. The cursor is moveable by following the user's gaze point. As aforementioned, a gaze point is the point of interest calculated based on the user's gaze vector falling on the screen 102. Thus, the current position of the cursor on the screen 102 is the gaze point obtained based on the user's current gaze. Put simply, by changing the gaze point, the user can control the position of the indicator on the screen 102. In the instant example as shown in the FIG. 2C, the user may simply look at the functional object “B” on the screen 102 to control the indicative cursor to move thereon. From the implementation aspect, the sensor 104 retrieves the positional data of the user's eyes and may be the head as well. The processor 110 processes and interprets the data. The position of the user's gaze point is therefore concluded and the processor 110 further instructs the cursor to move to the corresponding position on the screen 102.

In yet another embodiment, the user may command the electronic device 10 via the user interface 10 to perform a function in response to a facial-related function.

User interface 100 may include functional objects, once selected by the user, will cause the electronic device 10 to perform an underlying function. For instance, under a conventional operation on a mobile device, a click on an icon of an application on the screen will cause the electronic device 10 to run the application. Under the design of the instant disclosure, the series of operations are made through user motions. For instance, following the above example, assuming the object “B” is an icon of a map application. To instruct the electronic device 10 to execute the map application, firstly the user turns his/her eyesight toward the direction where the object “B” locates. As discussed above, the sensor 104 retrieves the positional change and the processor 110 consequently moves the cursor to the relevant position to indicate the object “B” is being selected. Additionally, as discussed above, a user motion may be predefined. When the user exercises the motion, a binding function is performed. In the instant embodiment, the binding function is a confirmation command for the selection. In the realm of conventional computer operation, it is like a click on the icon. Continuing to the example, once the object “B” is locked, the user may perform the binding user motion (e.g. a smile) to confirm the selection of the object “B”. In effect, the sensor 104 senses the facial motion and then causes the processor 110 to execute the map application. From the user's perspective, the only two things he/she needs to do are: look at the object “B” and smile, as simple as that and without any manual operations, the map application will then be launched.

Aside from receiving user motion-related commands via the user interface 100, instructions may be manually input to the electronic device 10 through the user input device 120. The user input device 120 may be, for instance, physical buttons, or sensors for sensing, hand and/or palm gestures. Although the user interface 100 and the user input device 120 are separately depicted in FIG. 1, they may be combined. For instance, the user input device 120 may be integrated with the screen 102 provided that the screen 102 is a touch-based screen.

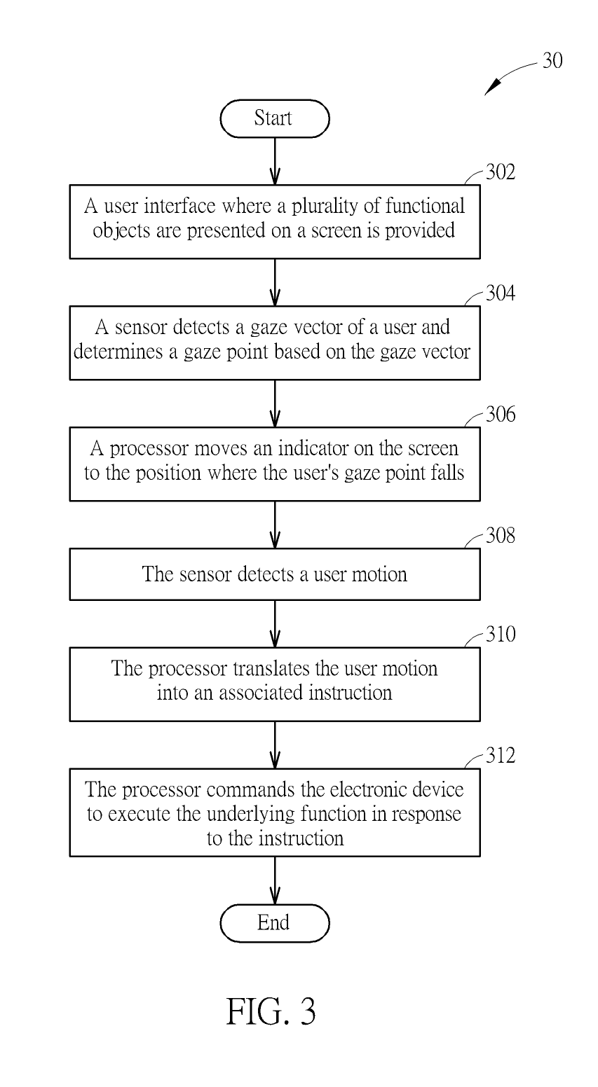

FIG. 3 illustrates a flowchart of a method 30 of instructing an electronic device via a user interface according to an embodiment of the present disclosure. The method includes the following actions.

In action 302, a user interface where a plurality of functional objects are presented on a screen is provided.

In action 304, a sensor detects a gaze vector of a user and determines a gaze point based on the gaze vector.

The gaze vector refers to the direction where the user is looking toward. The gaze vector may be obtained based on the head position, the head pose, the light reflected from the iris, the iris position and/or the pupil position, etc. The gaze vector may be defined by reference to a world coordinate system, a facial coordinate system, or a display coordinate system. The gaze point is a point of interest on the screen. It can be calculated based on the gaze vector.

In action 306, a processor moves an indicator on the screen to the position where the user's gaze point falls.

In action 308, the sensor detects a user motion.

The user motion may be a facial-related motion, an eye-related motion, or a head-related motion. In any case, the user motion must be predefined and associated with an instruction for performing a binding function.

In action 310, the processor translates the user motion into an associated instruction.

In another instance, the instruction is a made by the user via pressing a physical button, inputting a specific hand gesture, or inputting with a touch screen.

In action 312, the processor commands the electronic device to execute the underlying function in response to the instruction.

In some implementations, the sensor 104 may continuously retrieve head-related motions. Precisely, the sensor 104 may obtain the real-time position of the user's head. The movement of the user's head may be used by the processor 110 to a control a page's up and/or down on the screen 102. For instance, the page is scrolled down if the user moves his/her head down, and scrolled up if the user turns the head upward. Similarly, if the user turns the head to the left, the sensor 104 detects the movement and the processor 110 consequently turns the page to the next one; or if the users turns the head to right, the screen 102 displays the previous page instead. Alternatively, the page's size may be largely designed and therefore exceed the size of the screen 102. In the instance, the processor 110 may decide to partially display the page on the screen 102 while leave some portions unseen (i.e. hidden part) to the user. To see the hidden part, the user may turn the head right to move the page right to see the hidden part on the left; or turn the head left to move the page to the left accordingly to see the unseen portion on the right. As mentioned, the head-related motions are predefined and associated with the aforementioned instructions. When the sensor 104 detects a head motion, the processor 110 translates the motion into the corresponding instruction and control the display of the page accordingly on the screen 102. In the convention way that users may have to manually go through pages over pages through arrangements likes a mouse or a touch pad. However, under the design of the instant disclosure, none of the actions are hand-operated. Users, especially the driver in a vehicle, can therefore focus on driving without distraction.

In yet embodiment, the page may be zoomed in or out depending on the movement of the user's head. Specifically, the page is enlarged if the user leans toward screen 102. On the other hand, the page is zoomed out if the user moves the head away from the screen 102. As mentioned, the sensor 102 retrieves the positional change and the processor 110 translates the motion into the corresponding instruction and controls electronic device 10 to show the portion of the page on the screen 102 accordingly. Apart from the above, the head-related motions may further include head-tilted and rotations. For example, if the user tiles the head to the left, the page is instructed to pan left as well. And if the user tilts the head to the right-hand side, the page is instructed to pan right. However, the present disclosure is not limited thereto. In the present disclosure, the page can be displayed in response to the given instruction issued by the user through user motions.

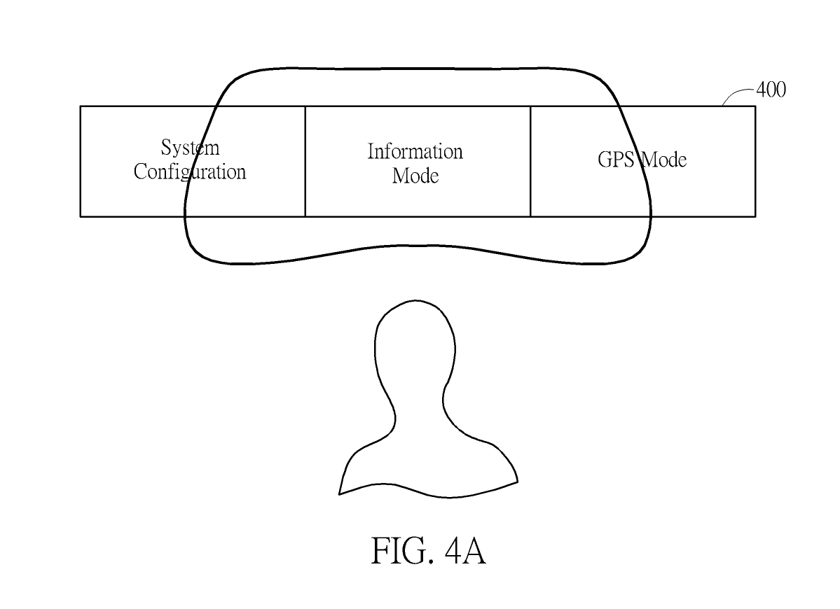

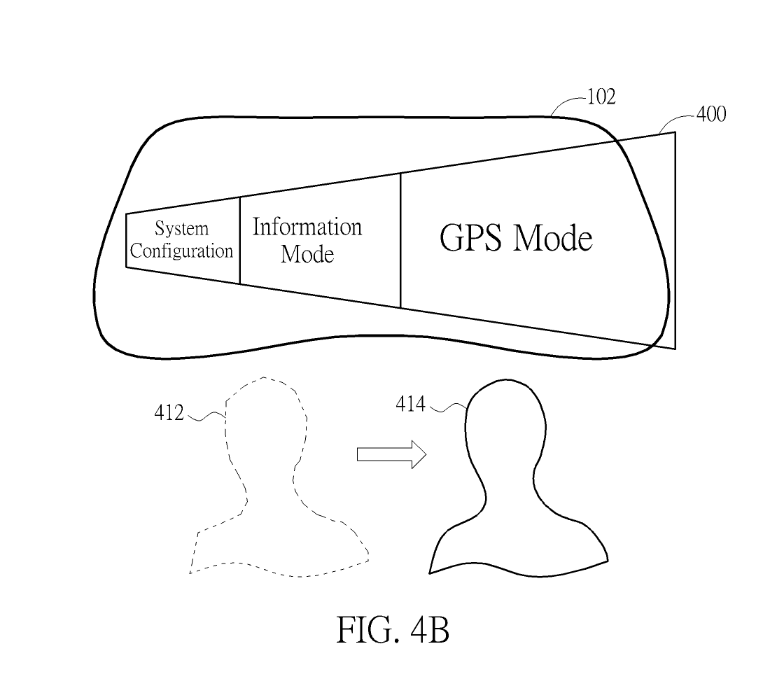

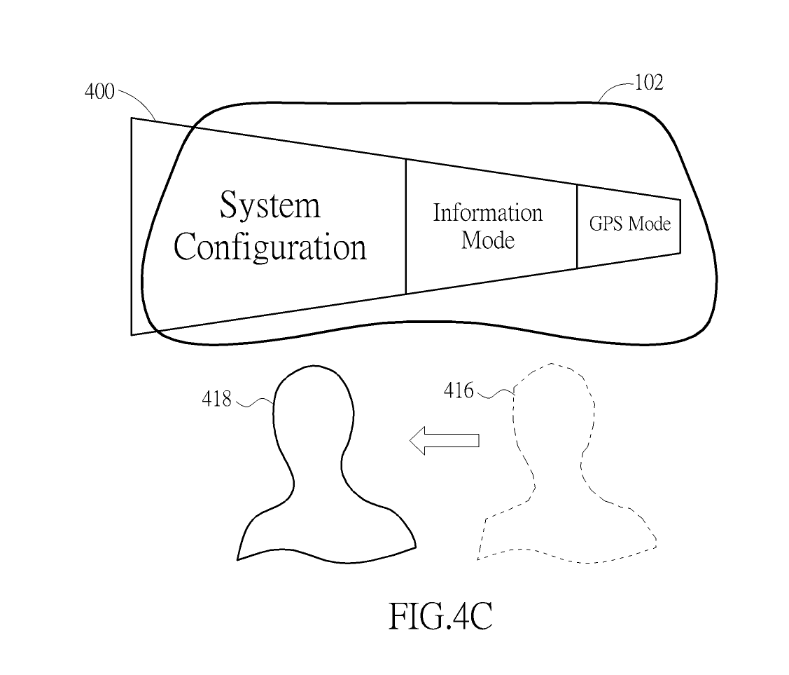

FIGS. 4A-4C illustrate schematic diagrams of a detailed implementations of controlling the screen 102 to display a page 400 according to head-related motions. In this embodiment, several head-related motions are predefined and associated with various instructions. The instructions may include an instruction to pan a page on the screen right, an instruction to pan a page on the screen left, an instruction to zoom in a page, an instruction to zoom out a page, and an instruction to move an indicator on the screen to a designated position, an instruction to confirmation a selection of a functional object on the screen, etc.

In the instant embodiment, a page 400 containing three functional objects are designed. The three items include: “System Configuration”, “Information Mode”, and “GPS Mode”. Each of the functional objects carries an underlying function as stated by its label. As shown in FIG. 4A, given the size limitation, the screen 102 can only display a partial of the page 400 centering the “Information Mode.” Assuming the user wants to select either the “System Configuration” or “GPS Mode” parts, under the design of the present disclosure, the user may simply perform a head-related motion to adjust the page on the screen 102. For instance, as shown in FIG. 4B, the user may move his/her head right (e.g., from the position 412 to the position 414), the sensor 104 detects the movement, and the processor 110 translates the movement to a corresponding instruction which consequently twists the page 400 and therefore reveals the previously unseen portion at the right-hand side, i.e. the “GPS Mode.” Under such operation, the user can easily select the GPS Mode object without obstacle. Alternatively, as shown in FIG. 4C, if the user moves his/her head to the left, (e.g., from the position 416 to the position 418), the sensor 104 detects the head movement, and the processor 110 translates the movement to a corresponding instruction which causes the page 400 to reshaped as depicted in FIG. 4C so that the user is able to select the “System Configuration” object conveniently.

In this embodiment, the functional objects on the page are arranged in a row; while in another embodiment, the functional objects may be arranged in other layouts, e.g., an arc. In such condition, when a rightward movement is detected, the processor 110 instructs the page to move clockwise. Similarly, when a leftward movement is detected, the processor 110 instructs the page to move counterclockwise.

In one embodiment, the electronic device 10 may be an automotive electronic device, and operated by the driver. For instance, the screen 102 may be a screen of a dashboard, and the page 400 displayed thereon contains abundant of vehicle information. For example, if the “Information Mode” is selected, the screen 102 may show vehicle information such as the weather, time and travel route(s). If the “GPS Mode” is selected, the screen 102 may show GPS navigation information such as a map and destinations. Further, if the “System Configuration” is selected, the screen 102 may show the configuration menu for the dashboard's settings. It should be noted that the functional objects on the page 400 are not limited to these three; and in other embodiments, there could be other functional objects such as “a speedometer information”, “a dashboard camera information”, “connecting to remote mobile device mode”. The display and the selection of any of the functional objects may be conducted through a user motion as discussed previously.

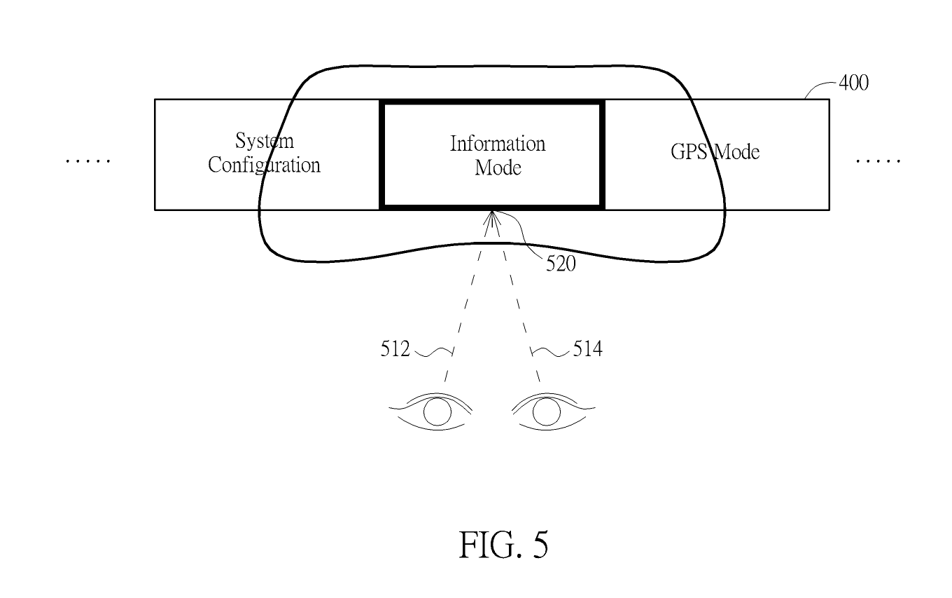

Apart from the head-related motions, the sensor 104 may also detect the eye-related motions. Similarly, several eye-related motions are predefined and associated with instructions. In one embodiment, the instructions may include an instruction to move an indicator on the screen in a designated direction. The indicator may be realized in various manners, such as a cursor, an icon, an outline, or a specific color to indicate what functional object or an area of the screen is being selected. FIG. 5 illustrates a schematic diagram of the control of the position of an indicator on the screen according to the eye-related motions. Assuming a page 400 containing three functional objects is shown on the screen 102. As shown, assuming the sensor 104 detects that the user is gazing at the “Information Mode” by referencing to the user's gaze vectors 512 and 514, and the gaze point 520, the processor 110 then instructs the indicator on the screen to move to “Information Mode”.

In the example of FIG. 5, the indicator is realized by adding a bold outline on the selection item. However, those skilled in the art should understand that the indicator may be implemented in other manners. For example, the indicator may mark a selection item or area with a brighter outline, a specific color, or some other indications allowing the user to clearly identify the position of the indicator. In another embodiment, the indicator may be implemented by a cursor, which moves to any direction corresponding to the user's gaze point. The user may control the indicator to move with eye gaze, as if the indicator is controlled by a mouse or a touch gesture. Nevertheless, in this embodiment, the operation is accomplished without any hand operations.

Once the indicator is on the desired position where a functional object is being selected, the processor 110 determines whether a confirmation command is received. In one embodiment, the confirmation command may be issued through the user input device 120. When the selection is confirmed, the processor 110 controls the electronic device 10 to perform the underlying function in response to the selected functional object. In another embodiment, the confirmation command may be given by facial-related motions detectable by the sensor 104. The confirmation command (regardless how it is performed, through a facial-related motion or the user input device 120) is in effect similar to a click operation of a mouse or a touch pad.

The facial-related motions may be in various forms. For example, they may be any facial expressions such as a smile, a laugh, an opened mouth, or a wrinkled nose. The facial expression may further be a series of dynamic facial motions. The facial expression may be enrolled and associated with instructions in advance. For example, a user may associate a smile (i.e., the rising of the mouth corners) with a performance of a binding function (e.g. a confirmation command for a selection). When the sensor 104 detects that the user smiles (i.e. the user's mouth corners rise), the processor interprets the smile and translates it into a confirmation command.

An exemplary operation of performing an underlying function according to the facial-relate motion is described with reference to FIGS. 4A-5. Assuming several head-, eye- and facial-related motions are predefined and associated with various instructions. For instance, as discussed above, a movement of head is associated with an instruction to adjust a page containing a plurality of functional objects displayed on the screen 102, a movement of eyesight is associated with an instruction to move an indicator on the screen 102, and a smile is associated with a confirmation command for confirming a selection of a functional object. Also, a page 400 containing three functional objects is displayed on the screen 102 as shown in FIG. 4A. Assuming that the user wants to see the vehicle information. From the user's perspective, to begin with, since the “Information Mode” is already on the screen, the user may simply sweep the eyesight to land the indicator on the “Information Mode,” and then smiles to confirm the selection. Specifically, the sensor 104 firstly detects the location of the gaze point of the user on the screen 102 and causes the processor 110 to move the indicator to the desired position on the screen 102 accordingly. Subsequently, the sensor 104 detects the smile, and the processor 110 then interprets the smile and translates it into the binding function, i.e. a confirmation command. Once the confirmation command is received, the electronic device 10 executes the underlying function of the selected function object. In the instant example, the “Information Mode” is selected and confirmed, the electronic device 10 displays vehicle-related information on the screen 102.

In another embodiment, the identity of the user may also be considered. The function is critical in shared car scenarios. That is, even for the same user motion, different person may associate it with different functions. For instance, for a first user, a smile may be associated with an instruction to confirmation; while for a second user, a smile may be an instruction to quit the selection. The details as to how to distinguish users based on facial features are discussed in the '053 application and will be skipped in the present disclosure.

The above detections and recognition of head-, eye- and facial-related motions may be achieved through computer vision technologies. For instance, the sensor 104 obtains a head photo of the user. The processor 110 then removes irrelevant parts, down-samples the photo, and then retrieves the head image via some sort of facial detection/recognition technologies to delineate the boundary of the head image (i.e. a bounding box). The operation of down sampling is optional to the present disclosure; the upside is it will reduce the data volume and therefore increases the processing speed. The processor 110 may then retrieve the image contents within the bounding box to further processing. The detections of head-, eye- and facial-related motions may be obtained from the image contents within the bounding box.

The processor 110 may apply facial landmark detection technologies to obtain the landmark position of facial features such as eyes, mouth and noise. The processor 110 obtains the head-related motions of the user to determine the head pose such as the head position, movement, or whether the head tilts or rotates. The processor 110 may further determine the iris position, the pupil position and/or the light reflected from the iris from an eye image, to calculate the gaze vector and the gaze point of the user. The processor 110 may further determine the facial expression according to variations on a specific area or a part of a facial feature, or according to a series of dynamic facial variations. For example, a smile is determined when it is detected that the corners of mouth are rised. The position(s) of each facial features may further be considered to determine the landmarks. The above are mere examples to illustrate how a head-, eye-, and/or a facial-related motion may be detected, and under no circumstance become a limitation to the present disclosure.

In the present disclosure, a hand-free user machine interface is disclosed. Those skilled in the art may make modifications and alternations accordingly. For example, in the above embodiments, the head, eyes and facial motions are associated with various of display instructions. By performing those motions, the user can easily adjust the content and/or the position of a page shown on the screen. Further, the user motions may also be associated with various instructions/functions. Once a motion is made, it will lead the electronic device to perform the underlying function.

It should be noted that the present disclosure may also be working in conjunction with other hand-free user interface, such as voice commands, gesture commands, etc.

Additionally, the user interface of the present disclosure may also be implemented on electronic devices of any kind. The electronic devices may include, an in-vehicle electronic system, a video game console, a handheld device, an e-book reader, etc.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of commanding an electronic device, comprising:
providing a user interface where a plurality of functional objects are presented on a screen, wherein each of the functional objects has an underlying function;
detecting at least one user motion;
translating the user motion to at least one instruction, wherein the instruction includes a selection of one functional object; and
instructing the electronic device to perform the underlying function of the selected functional object.

2. The method of claim 1, wherein the functional objects are laid out on a page; and wherein the user motion includes a head-related motion operable to instruct the electronic device to pan, zoom in or zoom out the page.

3. The method of claim 1, wherein the user interface further comprises an indicator on the screen to indicate the selection of one of the functional objects.

4. The method of claim 3, wherein the user motion includes an eye-related motion operable to instruct the electronic device to move the indicator on the screen in response to the eye-related motion.

5. The method of claim 4, wherein the user's gaze vector and gaze point are calculated to determine the position of the indicator.

6. The method of claim 5, wherein the indicator lands on the user's gaze point on the screen.

7. The method of claim 1, wherein the user motion includes a facial-related motion operable as a confirmation for the selection of the functional object in response to the facial-related motion.

8. The method of claim 1, wherein each of the user motions is predefined and associate with an instruction; wherein a performance of a user motion leads to an execution of the instruction.

9. An electronic device having a hand-free user interface, comprising:
a display displaying a page containing a plurality of functional objects, wherein each of the functional objects has an underlying function;
a sensor configured to receive at least one user motion made by a user; and
a processor configured to translate the user motion into at least one instruction, wherein the instruction includes a selection of one of the functional objects;
wherein, upon a confirmation of the selection, the processor causes the electronic device to perform the underlying function of the selected functional object.

10. The electronic device of claim 9, wherein the sensor is configured to detect a head-related motion operable by the processor to instruct the electronic device to pan, zoom in or zoom out the page on the display in response to the head-related motion.

11. The electronic device of claim 9, wherein the sensor is configured to detect an eye-related motion operable by the processor to instruct the electronic device to move a position of an indicator on the display in response to the eye-related motion.

12. The electronic device of claim 11, wherein the indicator is provided to indicate the selection of a functional object.

13. The electronic device of claim 11, wherein the position of the indicator is calculated by the processor by reference to the user's gaze vector and gaze point.

14. The electronic device of claim 9, wherein the sensor is configured to detect a facial-related motion operable by the processor to confirm the selection of the functional object in response to the facial-related motion.

15. The electronic device of claim 9, the user motion is predefined and associate with the instruction; wherein a performance of the user motion leads to an execution of the instruction.

16. The electronic device of claim 9, further comprising a user input device operable by the user to confirm the selection of the functional object.

17. An electronic device having a user interface upon which a user commands the electronic device through a plurality of user motions associated with instructions to the electronic device, comprising:
a display configured to display a page containing a plurality of functional objects to the user, wherein each of the functional objects corresponds to an underlying function;
a sensor configured to detect at least an eye-related motion; and
a processor configured to translate the eye-related motion into an instruction operable to move an indicator on the display for a selection of one of the functional objects;
wherein the eye-related motion is determined based on the user's gaze vector and gaze point on the display;
wherein, upon a confirmation of the selection, the processor causes the electronic device to perform the underlying function of the selected functional object.

18. The electronic device of claim 17, wherein the sensor is further configured to detect a head-related motion of the user; wherein the head-related motion is associated with an instruction operable by the processor to pan, zoom in, or zoom out the page on the display in response to the head-head-related motion.

19. The electronic device of claim 17, wherein the sensor is further configured to detect a facial-related motion of the user; wherein the facial-related motion is associated with an instruction operable by the processor to confirm the selection of the selected functional object in response to the facial-related motion.

20. The electronic device of claim 17, further comprising a user input device operable by the user to confirm the selection of the functional object.
